(19) United States
(12) Patent Application Publication
(10) Pub. No.: US 2004/0219933 A1
(43) Pub. Date: Nov. 4, 2004

(54) Transportation ordering system

(75) Inventor: Jonathan David Faith, London (GB)

Correspondence Address: SUGHRUE MION, PLLC, 2100 PENNSYLVANIA AVENUE, N.W., SUITE 800, WASHINGTON, DC, 20037, US

(73) Assignee: JOHNATHAN DAVID FAITH

(21) Appl. No.: 10/771,306

(22) Filed: Feb. 5, 2004

(30) Foreign Application Priority Data
Feb. 7, 2003 (GB) 0302886.7

(51) Int. Cl. H04Q 7/20

(52) U.S. Cl. 455/456.3

(57) ABSTRACT

A method for ordering transportation by means of a communication system comprising a plurality of consumer mobile communication terminals (CMCTs), a plurality of transportation mobile communication terminals (TMCTs) each located in a mobile transportation vehicle, a transportation ordering server, and a communication network by means of which the transportation ordering server may communicate with the CMCTs and the TMCTs; the method comprising: transmitting from one of the CMCTs to the server a primary request message indicating a request for transportation and indicating a location at which transportation is required; receiving the primary request message at the server and in response to the primary request message transmitting to two or more of the TMCTs a secondary request message indicating a request for transportation and including information defining the request for transportation and indicating at least the location at which transportation is required; receiving the secondary request messages at the said two or more TMCTs; transmitting from at least some of the said two or one or more TMCTs to the server a primary response message including information defining a set of transportation characteristics including at least an estimated time to arrival at the location at which transport is required; receiving the primary response messages at the server, and transmitting to the said one of the CMCTs one or more secondary response messages indicating the sets of transportation characteristics; receiving the secondary response messages at the said one of the CMCTs and presenting the sets of transportation characteristics to a user thereof; and transmitting from the said one of the CMCTs a primary acceptance message indicating acceptance of one of the sets of characteristics.

### BACKGROUND OF THE INVENTION

This invention relates to a system for ordering transportation, for example taxis, hire cars or couriers.

When someone wishes to order a taxi it is normal for him to phone a taxi company and request the taxi. The taxi company determines which of its taxis is best placed to meet the order, and that taxi is sent to pick up the person placing the order. The person placing the order normally places his order with only one taxi company; otherwise several taxis might arrive to try to meet the order.

There are a number of ways in which the taxi company may determine which of its taxis is to take the order. Some examples of these are described in WO 01/72078, EP 1 091 311, U.S. Pat. No. 6,014,430, WO 95/19679, U.S. Pat. No. 5,973,619 and GB 2 367 979. One common system is for the taxis to be fitted with units that can communicate with the taxi company's office. The taxi company broadcasts details of new orders to the units, and one of the taxi drivers accepts the order and communicates his acceptance to the taxi company's office using the unit in his taxi.

The most important factors to the person ordering the taxi are likely to be response time (the time between him placing the order and the taxi arriving to pick him up) and the cost of the journey.

The systems described above have several disadvantages. First, there might be several available taxi drivers or taxi companies, but when the person ordering the taxi places the order he does not know which of them will be able to provide the combination of response time and cost that best fits his needs. He could attempt to overcome this by ordering taxis from several companies, but this would be time-consuming and might result in several taxis arriving to meet the order. Second, there is no means for even the taxi drivers of a single company to offer flexibility in their response times and charges. For example, a taxi driver might be nearby the required pick-up, but might be having his lunch. In that case he might be prepared to take the job (and provide a fast response time), but for an increased price. Since current systems provide no means for taking this situation into account, under current systems drivers who temporarily do not want to take work at the standard rate simply do not accept jobs. This results in a loss of efficiency.

Similar problems apply to other transportation situations such as ordering courier services and ordering hire cars. A person may require a courier to arrive to pick up a package, or a hire car to be delivered. Different courier companies may be able to provide a range of pick-up or delivery times and a range of prices, and different hire car companies may be able to provide a range of delivery times, car types and prices. It would be desirable for a user to be able to conveniently select the combination of these factors that best meets his needs, without making numerous phone calls or ordering from more than one company.

The present invention aims to at least partially address these problems.

### SUMMARY OF THE INVENTION

According to the present invention there is provided a method for ordering transportation by means of a communication system comprising a plurality of consumer mobile communication terminals (CMCTs), a plurality of transportation mobile communication terminals (TMCTs) each located in a mobile transportation vehicle, a transportation ordering server, and a communication network by means of which the transportation ordering server may communicate with the CMCTs and the TMCTs; the method comprising: transmitting from one of the CMCTs to the server a primary request message indicating a request for transportation and indicating a location at which transportation is required; receiving the primary request message at the server and in response to the primary request message transmitting to two or more of the TMCTs a secondary request message indicating a request for transportation and including information defining the request for transportation and indicating at least the location at which transportation is required; receiving the secondary request messages at the said two or more TMCTs; transmitting from at least some of the said two or one or more TMCTs to the server a primary response message including information defining a set of transportation characteristics including at least an estimated time to arrival at the location at which transport is required; receiving the primary response messages at the server, and transmitting to the said one of the CMCTs one or more secondary response messages indicating the sets of transportation characteristics; receiving the secondary response messages at the said one of the CMCTs and presenting the sets of transportation characteristics to a user thereof; and transmitting from the said one of the CMCTs a primary acceptance message indicating acceptance of one of the sets of characteristics.

The request for transportation may indicate a destination for requested transportation and/or other characteristics of the required transportation. Each set of transportation characteristics may include an indication of a price and/or tariff for transportation.

Preferably the server stores a list of the addresses of the TMCTs. Then, in response to the primary request message the server may retrieve the addresses of the said two or more of the TMCTs from the store and transmit each secondary request message to one of the addresses so retrieved. Preferably the server also stores a list of the addresses of the TMCTs from which it received the primary response messages, and in response to the primary acceptance message transmits to the TMCT that sent the said one of the sets of characteristics a secondary acceptance message indicating acceptance of the set of characteristics. The server may, in response to the primary acceptance message, transmit to the or each TMCT that sent a set of characteristics other than the said one of the sets of characteristics a rejection, message indicating rejection of the respective set of characteristics.

Preferably some of the said two or more TMCTs store rules defining the formation of the said transportation characteristics and the method comprises automatically forming at those TMCTs the transportation characteristics to be transmitted from those TMCTs. At least some of the rules may be programmed into the respective TMCTs by a user thereof. The rules may include price and/or tariff determination rules, which may take as input factors including time of day, day of week, and the said location. The rules may include automatic routing rules, whereby a journey time to the said location from the current location of the vehicle carrying the respective TMCT may be determined. The TMCT is preferably capable of automatically estimating its own location.

The method may comprise presenting the information defining the request for transportation to users of at least one of the said two or more TMCTs. This may be done visually and/or audibly, or in other ways. The method may also comprise receiving input from a user of the said at least one of the said two or more TMCTs indicating the transportation characteristics to be transmitted from that TMCTs.

Preferably each CMCT stores the address of the server and includes an application that is arranged to receive user input indicating a request for transportation and in response thereto can transmit the primary request message to the server at the stored address. Preferably each CMCT is capable of automatically determining its location. The method preferably comprises forming the primary request message by automatically determining the location of the said one of the CMCTs and indicating that location as the location at which transport is required.

Each CMCT is preferably a radio communication terminal. Each CMCT is preferably a mobile phone.

Each TMCT is preferably a radio communication terminal. The TMCTs may use a mobile phone network for communication with the server.

Preferably the method includes providing a transportation service to the user of the said one of the CMCTs in accordance with the accepted set of characteristics and by means of the vehicle carrying the TMCT that transmitted the accepted set of characteristics.

The present invention will now be described by way of example with reference to the accompanying drawings.

### BRIEF DESCRIPTION OF THE DRAWING

In the drawing:

FIG. 1 is a schematic diagram of a taxi ordering system.

### DETAILED DESCRIPTION OF THE INVENTION

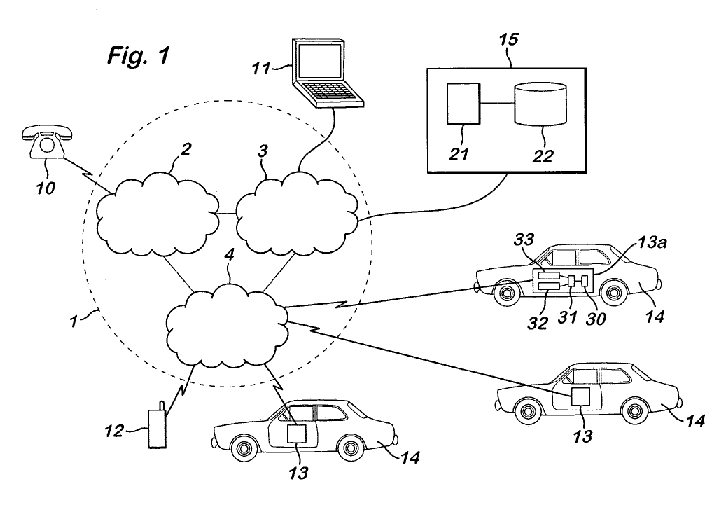

The system of FIG. 1 comprises a communication network shown generally at 1, including a wired phone network 2, a data network such as the internet 3 and a mobile phone network 4. Terminals 10 to 13 connected to the networks 2 to 4 can communicate with each other. The terminals include a wired phone 10, a personal computer 11, a mobile phone 12 and mobile data terminals 13 carried by taxis 14. The terminals can also communicate with a transportation server 15 connected to the data network 3.

Each of the terminals has a unique address by which it may be contacted. This may be a phone number and/or an internet protocol (IP) address, or another form of address depending on the detail of the networks.

The server 15 is configured to support ordering of transportation services by terminals such as terminals 10 to 12. The server has a processing section 20, which performs the processing necessary to perform that function, and a data store 21, which stores the necessary data. The store 21 holds the addresses of the data terminals 13 located in the taxis which can provide the transportation services. The server also supports interface functions whereby it can exchange data with the terminals 10 to 13. The terminals may be specially configured to interoperate with the server, or the server and the terminals may interoperate using standard protocols. This will be described in more detail below.

The general operation of the system is as follows. When a user of one of the terminals 10 to 12 wishes to order a taxi he operates his terminal so as to contact the server 15. He provides the server with details of the order, such as the location from which the pick-up is to be made, the time when the pick-up is required and the destination. The server forwards these order details to the taxi terminals 13. The operator of each taxi terminal (who would typically be the driver of the respective taxi) can then review the order details he has received and either ignore/delete them or respond to the server with offer details indicating the criteria on which he could meet the order. The offer details could include the response time and the tariff to be charged if the offer is accepted. On receiving offer details the server forwards them to the terminal from which the order was placed. That terminal presents its user with the offer details that have been received so far. The terminal could compare newly received offers with stored previously received offers and could present a newly received offer to a user only if the newly received offer is better in at least one criterion than all stored previously received offers. Alternatively, or in addition, a similar function could be performed at the server. The server could store all offers previously forwarded to a terminal in response to an order (or only a certain number of the best such offers), compare new offers to the stored offer(s) and forward them to the terminal only if they are better in at least one criterion than all previously stored offers.

The user selects one of the sets of offer details, and causes his terminal to transmit an acceptance message to the server. The acceptance message indicates which of the offer details has been accepted. On receiving the acceptance message the server transmits an acceptance message to the taxi terminal whose offer has been accepted, and transmits rejection messages to the taxi terminals whose offers have not been accepted. The taxi terminal receiving the acceptance message presents it to the user of that terminal, who can then fulfil the order. An offer may be associated with an expiry time, for example 2 minutes after the offer was placed, and may expire after that time.

Once an acceptance has been received at a taxi terminal the taxi terminal acknowledges receipt of that acceptance using another message sent to the user's terminal via the server. In response to such an acknowledgement message the server may prevent offers being sent to that taxi terminal for a period of time, for example 10 minutes.

When an offer from a taxi terminal is accepted it may automatically cancel other offers it has made that are still open, or the server may do so.

Various forms of interface may be implemented for communications in either or both directions between the terminals 10 to 13 and the server 15. In one example, the terminals are each pre-loaded with a dedicated application for communicating with the server. This could, for example, be a Java application. When a user wishes to order a taxi he activates the application by running it on his terminal. The application prompts the user for the order details, and transmits the order details submitted by the user to the server. The application also handles the subsequent messaging between the terminal and the server, and the display of offer data and progress updates as described below. The application may be selected form a control menu of the terminal. This type of interface is particularly suited to devices such as multimedia-capable mobile phones (e.g. terminal 12) and PDAs (personal digital assistants). In another example, the server may provide data to the terminal in audio form, for example as voice prompts and voice reports. The terminal could return data to the server as DTMF (data tone multi-frequency) tones, or as voice data that could be recognised by a voice recognition system of the server. This type of interface is particularly suited to standard land-line telephones (e.g. terminal 10) which may have no display and no local data processing capabilities. In another example, the server may provide data to the terminal in the form of an HTML (hyper-text mark-up language) web page, and may receive data from the terminal through an HTML form. This type of interface is particularly suited to computers and other devices equipped with web browsers. In another example, the information may be transferred between the terminals and the server by means of discrete messages, for example SMS (short message service) or MMS (multi-media messaging service) messages or e-mails. SMS and MMS messages are particularly suitable when the terminal is a mobile phone that supports such messages. The terminal could take other forms, for example a radio capable watch.

The order details include the location from which the pick-up is to be made. This will normally be the current location of the user of the terminal that places the order. The terminal is preferably capable of automatically determining the location of the user, and submitting this to the server as part of the order details. This may be done in a number of ways. If the terminal is operating in a mobile phone network then the location of the terminal may be determined through the locationing functions of the network. For example, in a GSM (Global System for Mobile Communications) system the location of the terminal may be determined from the cell in which the terminal is operating. This may give a resolution of 100 m or less in urban areas, but more in rural areas with larger cells. More accurate locationing services may be available in enhanced GSM systems. In other systems, such as the 3G (Third-Generation) or UMTS (Universal Mobile Telecommunication System) the more accurate locationing services which are available in those systems may be used to determine the terminal's location. These services may, for example be ToA (time of arrival) locationing services. Alternatively, the terminal may include a receiver for satellite location signals such as those of the GPS (Global Positioning System), by means of which its location may be determined. If the terminal is capable of determining its own location automatically then when the user is entering the order details he is preferably asked whether the pick-up is from his current location. If it is, then the terminal determines its location and uses that as the pick-up location in the order details. Otherwise the user is asked for the pick-up location in the same way as if the terminal were not capable of determining its location. The user can suitably provide the location as a street address, or as an intersection identified by the intersecting roads and optionally the city where the intersection is, or as a postcode or zip code together with a house number if necessary, or as co-ordinates (e.g. a grid reference or latitude and longitude). The location could be input be the user indicating a location on a map displayed by the device. A destination location may also be provided in these ways.

If the server is aware of the locations of the taxi terminals it could only signal a new order to those taxi terminals that are within a predetermined radius of the pick-up location of the order. This reduces data traffic and reduces the load on taxi drivers or taxi terminals in processing the offers.

The order details can include each of the following items of data defining the order:

pick-up location

destination location (optional)

time of pick-up (optional, as the required pick-up can be assumed to be immediate if this is not provided)

number of passengers

the passenger requires a female driver

the passenger has bulky luggage

the passenger requires to pay be a certain method, for example credit card

Optionally additional information such as the name of the person placing the request, and his billing details may also be provided.

When the order request arrives at the server it forwards the details of the order to the taxi terminals 13 whose addresses it has stored. Taxi drivers may register with the operator of the server to have their terminals' address stored. The operator of the server may make a charge for the storing of the address, or for the forwarding of order details.

The main components of the taxi terminal are shown schematically for terminal 13a in FIG. 1. The taxi terminal includes a radio transceiver 30, a processing unit 31 including a data storage capabilities, a keypad 32 and a display 33. The radio transceiver enables the terminal to communicate with the server 15. It may do this directly, or via an intermediate network. In a preferred embodiment, the server is connected to the internet, and the radio transceiver 30 operates in mobile phone network 4 as an item of user equipment (UE) or the like. The processing unit is arranged to perform the necessary operations to support the taxi terminal's communication of data to and from the server, to display received data on the display 33 and to receive data entered by a user using the keypad 32. The keypad 32 could be a touch-sensitive membrane over the display 33, forming a touch screen. In addition to, or instead of the keypad, the terminal could have a voice recognition system for receiving hands-free input from a user.

When order details are received by a taxi terminal they can be processed manually by the terminal's user. In the manual processing mode the details are displayed on the display of the taxi terminal. The user decides on his response to the order and enters the offer details using the keypad. The offer details can include each of the following items of data defining the offer:

response time (estimated time before arrival at the pick-up location specified in the order details);

tariff (this may be defined in any suitable way, for example as an amount per mile and/or an hourly rate, or as a fixed price to take a customer to a destination specified in the order details).

In the automatic processing mode, the processing unit 31 of the taxi terminal automatically formulates the response based on pre-defined criteria supplied to it by the terminal's user. These may include the following:

Data indicating when to place an offer and when to delete/ignore an order. For example, the terminal may be configured to delete all offers that arrive when the taxi is busy on another job, or to delete all offers for non-immediate pick-ups whose pick-up times fall during pre-defined times when the driver of the taxi will not be working.

Data indicating how to determine the response time. For example, the terminal may be configured to determine its location (for instance using one of the automatic locationing methods described above), estimate the distance between the determined location and the pick-up location and then divide that distance by a pre-stored speed to estimate the response time. Alternatively, a more sophisticated system to estimate response time using automatic map routing and optionally real-time traffic status information could be employed. In such a system the terminal would have access to a database of roads or other routes and could use that to estimate a journey time from its current location, to the pick-up point, and via any drop-off point to which the taxi is currently heading. Routing systems of this general type are well-known in the automotive field.

Data indicating the tariff to be offered. Each driver may set his tariff individually.

Offer data received by the server is forwarded to the terminal of the user who placed the order. The offer data is preferably displayed in a unified visual display on the terminal, but it could be displayed as a series of discrete message views (e.g. if each offer data is transmitted to the terminal in a respective SMS message) or could be presented to the user in audio form using pre-recorded voice segments if the terminal has no display. The preferred unified display may appear as shown below:

| Offer number | Minutes to arrival | $ per mile | Minimum $ per hour |
|---|---|---|---|
| 1 | 10 | 2.00 | 20.00 |
| 2 | 15 | 1.60 | 18.00 |

The user can then view the available offers and select the one that best meets his requirements. In the example above, the user can select between offer 1, which has a shorter response time, and offer 2, which has a lower charge. The user could configure his terminal to automatically accept the best offer based on pre-stored criteria.

When the user accepts an offer he transmits to the server a message identifying the offer he has accepted, and the server transmits a message to the taxi terminal that made that offer to indicate that it has been accepted. To allow this to be done, the server stores the addresses of the taxi terminals that have made outstanding offers, and which order those offers were in response to. Using this data it can determine which taxi terminal made the successful offer, and also which other offers for the same order have not been accepted, so that it can signal the taxi terminals that made those offers to inform them that the offers have not been accepted. When an order is placed the server sets up a data record in its store for that offer. The data record includes the address of the terminal that made the request, the status of the request (“pending”, “offer accepted”, or “pick-up made”) and the order details, together with the offer details and the corresponding taxi terminal address for each offer received. The data record is updated as necessary.

The taxi terminals may provide the following additional functionality to drivers.

1. The taxi terminals could be integrated with automatic locationing systems, as described above, and accordingly could provide the driver with directions to specified locations, such as the pick-up and destination locations. The location of the terminal could be transmitted to a base so that a taxi company can keep track of where its taxis are.

2. During a fare-paying trip the display screen of the taxi terminal could display estimated minutes to arrival and direction of route. Directions are/can be announced verbally to the driver. A record could be kept of where a driver's actual route differs from the prescribed route. A customer could be charged only for the shortest route or the quickest route taking traffic conditions into account, whether the driver takes it or not. This would reassure customers that they are not being overcharged.

3. A driver could enter his expenses into the system, for example fuel and servicing, at the time of the expense.

4. The display screen of the taxi terminal could show a map coloured up to indicate where the recent orders are coming from together with rates per mile.

5. The taxi terminals could provide convenient access to emergency services, for example to issue an alarm call or to notify the police if the driver notices a suspicious situation in the street.

6. The taxi terminals could provide trading reports for drivers, including any of

a. revenue for day/week/year-to-date

b. revenue per hour

c. net profit for day/week/year-to-date

d. revenue and expenses for tax returns (VAT and Income Tax)

e. account with phone company

f. account with credit card company

g. summary of commission paid to operator of server

If the taxi terminal whose offer has been accepted is capable of frequently transmitting its location to the server then the server could transmit messages to the terminal that accepted the offer to indicate an updated estimated time of arrival as the taxi approaches.

Even if the terminal from which a request originates is not capable of determining its location sufficiently precisely that it can be used to directly form the pick-up data, rough automatic location data from the terminal or generated by the network may be used by the server to validate a pick-up address input manually by the user. This may be useful to avoid the system being overloaded by hoax orders.

The person placing the order could enter an approximate location for the pick-up, so as to allow accurate offers to be placed, and then negotiate a precise pick-up location with the successful driver once an offer has been accepted.

The person placing the order may pay the driver in cash or by credit card once he has been taken to his destination. Alternatively, if the terminal that he used to place the order has an account associated with it then the cost of the journey may be debited to that account. For example, if the order is placed using a phone, the journey may be charged to the phone's billing account. This may be done automatically by the server: when the taxi arrives at its destination the driver enters the total fare into his taxi terminal, an indication of that amount is transmitted from the taxi terminal to the server and the server debits the billing account of the terminal that placed the order (as indicated in the data record for the corresponding order) with that amount and credits the billing account of the taxi terminal with that amount less a commission taken by the operator of the server. The total fare could be calculated automatically by the server using the data in the data record for the corresponding order that indicates the tariff that has been accepted.

If the operators of the taxis have accounts with the server then if a taxi fails to pick up a customer, or is late for a pick-up then the server may penalise the operator of that taxi by debiting a fine to his account. In such a situation the passenger who ordered that taxi could be credited as a form of compensation.

An offer that has been made but that has not yet been accepted can be modified or withdrawn by the driver who made it, using his taxi terminal.

If an order is for a non-immediate (future) pick-up then shortly before the designated pick-up time the server could transmit messages (e.g. SMS messages) to the terminal that placed the order and the terminal whose offer was accepted to remind them of the order.

If a user orders a taxi but does not show up, or a taxi driver's offer is accepted but he does not fulfil it, then the server may make a penalty charge on the defaulting user or driver.

The server may keep records of management data, such as the best and average times to meet orders, and the accuracy of driver's estimates of arrival time.

As indicated above, the system may be used in other situations, for example to order hire cars or couriers, or other forms of transportation from one place to another.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method for ordering transportation by means of a communication system comprising a plurality of consumer mobile communication terminals (GMCTs), a plurality of transportation mobile communication terminals (TMCTs) each located in a mobile transportation vehicle, a transportation ordering server, and a communication network by means of which the transportation ordering server may communicate with the CMCTs and the TMCTs; the method comprising:
transmitting from one of the CMCTs to the server a primary request message indicating a request for transportation and indicating a location at which transportation is required;
receiving the primary request message at the server and in response to the primary request message transmitting to two or more of the TMCTs a secondary request message indicating a request for transportation and including information defining the request for transportation and indicating at least the location at which transportation is required;
receiving the secondary request messages at the said two or more TMCTs;
transmitting from at least some of the said two or one or more TMCTs to the server a primary response message including information defining a set of transportation characteristics including at least an estimated time to arrival at the location at which transport is required;
receiving the primary response messages at the server, and transmitting to the said one of the CMCTs one or more secondary response messages indicating the sets of transportation characteristics;
receiving the secondary response messages at the said one of the CMCTs and presenting the sets of transportation characteristics to a user thereof; and
transmitting from the said one of the CMCTs a primary acceptance message indicating acceptance of one of the sets of characteristics.

2. A method as claimed in claim 1, wherein the request for transportation indicates a destination for requested transportation.

3. A method as claimed in claim 1, wherein each set of transportation characteristics includes an indication of a price and/or tariff for transportation.

4. A method as claimed in claim 1, wherein the server stores a list of the addresses of the TMCTs, and in response to the primary request message retrieves the addresses of the said two or more of the TMCTs from the store and transmits each secondary request message to one of the addresses so retrieved.

5. A method as claimed in claim 1, wherein the server stores a list of the addresses of the TMCTs from which it received the primary response messages, and in response to the primary acceptance message the server transmits to the TMCT that sent the said one of the sets of characteristics a secondary acceptance message indicating acceptance of the set of characteristics.

6. A method as claimed in claim 5, wherein in response to the primary acceptance message the server transmits to the or each TMCT that sent a set of characteristics other than the said one of the sets of characteristics a rejection message indicating rejection of the respective set of characteristics.

7. A method as claimed in claim 1, wherein some of the said two or more TMCTs store rules defining the formation of the said transportation characteristics and the method comprises automatically forming at those TMCTs the transportation characteristics to be transmitted from those TMCTs.

8. A method as claimed in claim 1, comprising presenting the information defining the request for transportation to users of at least one of the said two or more TMCTs.

9. A method as claimed in claim 8, comprising receiving input from a user of the said at least one of the said two or more TMCTs indicating the transportation characteristics to be transmitted from that TMCTs.

10. A method as claimed in claim 1, wherein each CMCT stores the address of the server and includes an application that is arranged to receive user input indicating a request for transportation and in response thereto to transmit the primary request message to the server at the stored address.

11. A method as claimed in claim 10, wherein each CMCT is capable of automatically determining its location and the method comprises forming the primary request message by automatically determining the location of the said one of the CMCTs and indicating that location as the location at which transport is required.

12. A method as claimed in claim 1, wherein each CMCT is a radio communication terminal.

13. A method as claimed in claim 10, wherein each CMCT is a mobile phone.

14. A method as claimed in claim 1, wherein each TMCT is a radio communication terminal.
